(19) United States
(12) Patent Application Publication
(10) Pub. No.: US 2003/0052861 A1
(43) Pub. Date: Mar. 20, 2003

(54) Portable communication device with detachable joystick and method therefor

(76) Inventor: Jiang Peng, Alberta (CA)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/955,404

(22) Filed: Sep. 17, 2001

(51) Int. Cl. G09G 5/08

(52) U.S. Cl. 345/161

(57) ABSTRACT

Briefly, in accordance with one embodiment of the invention, a portable communication device such as, for example, a cellular phone, includes a detachable joystick. The detachable joystick may be used to move a cursor on a display of the portable communication device.

### BACKGROUND

Traditional portable communication devices such as, for example, cellular phones, may have several buttons that may be used to dial a number to be called. When the communication device is used to process or retrieve data, such as downloading data from the interenet, letters may be assigned to the buttons to allow the user to provide alpha-numeric input. However, the use of buttons is very difficult and time consuming when significant amounts of information is entered by the used.

Thus, there is a continuing need for better ways to allow users to provide input or operate portable communication devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram representation of a portable communication device in accordance with an embodiment of the present invention; and

FIG. 2 is an exemplary illustration of a portable communication device in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

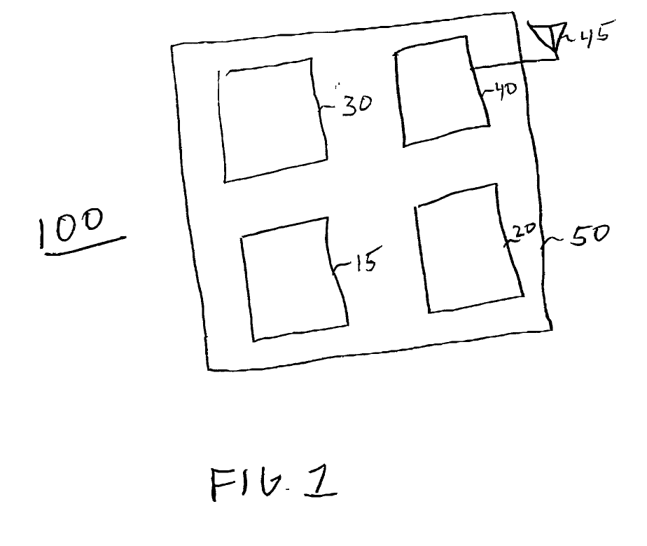

Turning to FIG. 1, an embodiment 100 in accordance with the present invention is described. Embodiment 100 may comprise a portable communication device 50 such as a mobile communication device (e.g., cell phone), a two-way radio communication system, a one-way pager, a two-way pager, a personal communication system (PCS), a portable computer, or the like. Although -it should be understood that the scope and application of the present invention is in no way limited to these examples.

Portable communication device 50 may comprise, for example, a microprocessor, a digital signal processor, a microcontroller, a processor 30 or the like. However, it should be understood that the scope of the present invention is not limited to these examples. Portable communication device 50 may also optionally include other components such as a display 15 and memory 20 (e.g. RAM or non-volatile memory). Memory 20 may be used to store messages transmitted to or by portable communication device 50. Memory 20 may also optionally be used to store instructions that are executed by processor 30 during the operation of portable communication device 50, and may be used to store user data such as the conditions for when a message is to be transmitted by portable communication device 50. As shown in FIG. 1, portable communication device 50 may also comprise a display 15 that may present the results of the execution of those instructions or other data to a user.

Portable communication device 50 may also comprise a communication module 40 that may use an antennae 45 to allow portable communication device 50 to wirelessly communicate with other users or networks (e.g. the internet, an intranet, etc.), although the scope of the present invention is not limited in this respect. Types of cellular radiotelephone communication systems intended to be within the scope of the present invention and that may be employed by communication module 40 include, although not limited to, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

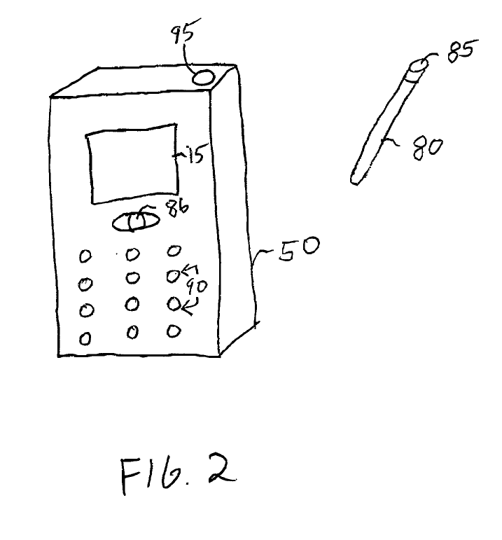

Turning now to FIG. 2, portable communication device 50 may also comprise a detachable joystick 80 that may be used by a user to provide input. Although the scope of the present invention is not limited in this respect, detachable joystick 80 may be placed by the user into a slot 86 so that movement of detachable joystick 80 corresponds to movement of a cursor in display 15. For example, slot 86 may allow detachable joystick 80 to be connected to motion sensors such that the user may provide input with the display an indicate movement across the display on a pixel-by-pixel basis. It should also be understood that the scope of the present invention is not limited in this respect, as alternatively, movement of detachable joystick 80 simply moves a cursor or items in a corresponding direction. Thus, the user may provide input or execute applications on portable communication device 50 using detachable joystick 80, numeric keypad buttons 90, or any combination thereof.

In alternative and optional embodiments, detachable joystick 80 may also comprise a depressible button 85 that may allow a user to provide input. For example, a user may depress depressible button 85 to select an icon on display 1 5, input data, or initiate an application to be executed by portable communication device 50.

Portable communication device 50 may also comprise a slot 95 that may be used to store detachable joystick 80 when not in use. In other embodiments, portable communication device 50 may have a clip or other storage mechanism for storing detachable joystick 80.

Alternatively and optionally, the operation of portable communication device 50 may be disabled upon the removal of detachable joystick 80 from slot 86 or upon placement into slot 95. For example, portable communication device may turn off or become inactive upon the removal of detachable joystick 80. Alternatively, a user may indicate to portable communication device 50 that is should enter a low-power or standby mode when detachable joystick 80 is removed from slot 86.

Similarly, portable communication device 50 may be enabled upon placement of detachable joystick 80 into slot 86, or alternatively, upon removal of detachable joystick 80 from slot 95, although the scope of the present invention is not limited in this respect. Thus, a user may turn on or awaken portable communication device 50 using detachable joystick 80.

In yet another alternative and optional embodiment of the present invention, a common writing utencil such as a pen or pencil may be used to as the detachable joystick. In other words, a writing device such as one of those having ink or lead, may be used to operate portable communication device 50. Accordingly, in this particular embodiment, slot 86 on portable communication device 50 may be adapted to receive a conventional pen so that the user can provide input (e.g. move a cursor or select icons on display 15) with the pen. This may be desirable so that the user need not keep track of a specialized joystick to be used with portable communication device 50. Alternatively, slot 86 may be adapted to receive any utencil having a similar shape and size (e.g. a key, finger, etc.). Accordingly, particular embodiments of the present invention may provide a more convenient and efficient manner for a user of a portable communication device to provide input or control use of the portable communication device (e.g. initiate a cellular communication using one of the communication standards described above).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A portable communication device comprising:
a display; and
a detachable joystick; wherein the portable communication device is adapted to receive the detachable joystick, and the detachable joystick provides a user input indicated with the display.

2. The portable communication device of claim 1, wherein the detachable joystick comprises a user depressible button.

3. The portable communication device of claim 1, wherein the portable communication device is further adapted to store the detachable joystick when not in use.

4. The portable communication device of claim 1, wherein the detachable joystick is adapted to indicate desired movement of a cursor on the display.

5. The portable communication device of claim 1, wherein the detachable joystick is adapted to select an icon on the display.

6. The portable communication device of claim 1, further comprising motion sensors to sense movement of the detachable joystick.

7. The portable communication device of claim 1, wherein an active operational mode of the portable communication device is initiated upon placement of the detachable joystick into the portable communication device.

8. The portable communication device of claim 1, wherein an inactive mode of the portable communication device is initiated upon removal of the detachable joystick into the portable communication device.

9. The portable communication device of claim 1, wherein the detachable joystick comprises ink.

10. The portable communication device of claim 1, wherein the detachable joystick is adapted to indicate movement across the display on a pixel-by-pixel basis.

11. The portable communication device of claim 1, wherein the portable communication device is a cellular phone.

12. A method comprising:
providing user input to a portable communication device using a detachable joystick.

13. The method of claim 12, further comprising moving the detachable joystick, wherein movement of the detachable joystick approximately corresponds to movement of a cursor on a display.

14. The method of claim 13, further comprising selecting an icon on the display.

15. The method of claim 14, further comprising depressing a button on the detachable joystick.

16. The method of claim 12, further comprising inserting the detachable joystick into the portable communication device.

17. The method of claim 16, wherein inserting the detachable joystick enables operation of the portable communication device.

18. The method of claim 12, further comprising initiating a cellular communication with the detachable joystick.

19. The method of claim 12, further comprising removing the detachable joystick from the portable communication device.

20. The method of claim 19, wherein removing the detachable joystick disables operation of the portable communication device.

21. An apparatus comprising:
a processor;
a static random access memory coupled to the processor;
communication module to transmit a wireless communication;
a display; and
a detachable joystick to provide a user input indicated with the display.

22. The apparatus of claim 21, wherein the detachable joystick comprises a user depressible button.

23. The apparatus of claim 1, wherein the apparatus is adapted to store the detachable joystick when not in use.

24. The apparatus of claim 21, wherein an active operational mode is initiated upon placement of the detachable joystick into the apparatus.

25. The apparatus of claim 21, wherein the detachable joystick comprises ink.
